(19) United States
(12) Patent Application Publication
(10) Pub. No.: US 2006/0235740 A1
(43) Pub. Date: Oct. 19, 2006

(54) System and method for calculating service staffing

(76) Inventors: Jeffrey Alexander Lea, (US); Juan Antonio Fernandez, (US)

Correspondence Address: Patrick S. Yoder;FLETCHER YODER, P.O. Box 692289, Houston, TX, 77269-2289, US

(21) Appl. No.: 11/107,227

(22) Filed: Apr. 15, 2005

(51) Int. Cl. G06F 17/30

(52) U.S. Cl. 705/10

(57) ABSTRACT

A technique is provided for automatically calculating an estimate of demand for field and for remote customer service, such as based on historical service data. A forecast may then be calculated based upon the estimate of demand and on a staffing plan allocating service personnel between field and remote assignments. Routines implementing some or all of the technique may be provided on a processor-based system or on a computer-readable medium.

### BACKGROUND

The invention relates generally to calculating and/or evaluating staffing requirements in an automated or semi-automated manner, such as by use of one or more automated routines.

In a variety of industrial, commercial, medical, and research contexts, various pieces of equipment may be employed on a day-to-day basis to accomplish or facilitate the work being performed at a facility. In many instances, the facility may rely upon a third party to provide service for some or all of the equipment at the site to ensure that the equipment remains operational and available. For example, in an industrial setting, production equipment or computer resources that are in operation in a continuous or near continuous manner may be serviced by an off-site party that provides servicing as needed or requested. Similarly, hospitals, clinics, and research facilities may utilize another party to service some or all of the diagnostic, monitoring, and/or imaging equipment at a site so that the equipment remains available where and when it is needed.

Such an arrangement, however, may impose burdens on the service provider that are difficult to overcome in an efficient and cost effective manner. For example, a service provider may utilize a combination of remote and field personnel to provide service to a variety of clients. In particular, remote personnel typically provide service in the form of phone support and assistance or remote system access and diagnosis while field personnel provide on-site support when remote support is insufficient. As one might expect, use of remote support, where possible, can provide cost and time savings for both the client and the service provider. However, a sufficient number of field personnel to provide necessary on-site service must still be maintained.

In some instances, field personnel may be utilized to provide remote, i.e., telephone, support when they are not needed or scheduled to be in the field. Such an arrangement allows the service provider to improve efficiency and cost effectiveness in situations where a more expensive and time-consuming on-site service call is not warranted. Deploying service personnel optimally between the remote and field locations, however, may be difficult. In particular, sufficient personnel should be allocated to the field to handle service situations best served by an on-site service call. Similarly, sufficient personnel should be allocated to remote service to minimize wait times, thereby reducing the “leaking” of remote service situations to the field, which occurs when an impatient client directly calls or pages field personnel to make an on-site call.

The allocation of service personnel is further complicated by the variability associated with both the number and timing of service calls which may occur in a day, a week, or a month. Similarly, the different types of equipment serviced, and the number of personnel qualified to service each equipment type, may further complicate the allocation of service personnel. Such variables may make it difficult to consistently allocate service personnel between the field and the remote service sites in a manner which is efficient and cost effective and which addresses the time and equipment needs of the customer.

### BRIEF DESCRIPTION

A method is provided for automatically calculating a forecast of service and staffing. The method comprises the step of automatically calculating an estimate of demand for field and for remote customer service. A forecast is automatically calculated based upon the estimate of demand and on a staffing plan allocating service personnel between field and remote assignments. System and computer-readable media are also provided for implementing the method.

### DRAWINGS

These and other features, aspects, and advantages of the present invention will become better understood when the following detailed description is read with reference to the accompanying drawings in which like characters represent like parts throughout the drawings, wherein:

FIG. 1 depicts an exemplary processor-based system for use in accordance with the present technique; and

FIG. 2 depicts a flowchart depicting exemplary steps in accordance with the present technique.

### DETAILED DESCRIPTION

The present technique provides an automated or semi-automated technique for evaluating or forecasting the allocation of remote and field personnel, such as personnel engaged in providing customer service or support. In particular, the present technique, when implemented on a computer platform, provides for the calculation of both remote and field service coverage based on a variety of data inputs, such as historical service data and planned staffing data. Based upon the calculated service coverage, adjustments may be made in the allocation of field and/or remote personnel to achieve the desired coverage.

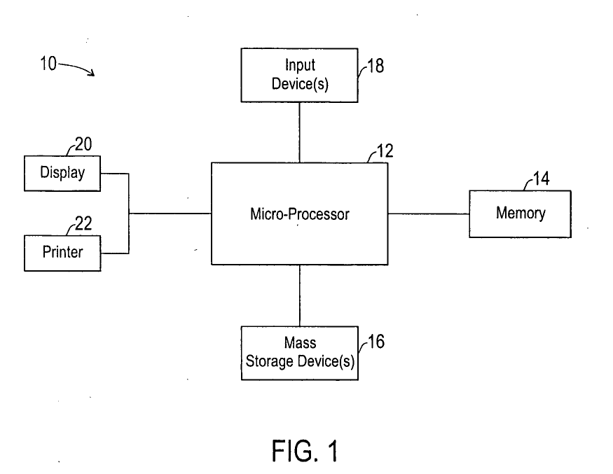

Referring now to FIG. 1, an exemplary processor-based system 10 for use in conjunction with the present technique is depicted. In one embodiment, the exemplary processor-based system 10 is a general-purpose computer configured run a variety of software, including software implementing all or part of the present technique. Alternatively, in another embodiment, the processor-based system 10 is an application specific computer or workstation configured to implement all or part of the present technique based on specialized software and/or hardware provided as part of the system.

In general, the exemplary processor-based system 10 includes a microprocessor 12, such as a central processing unit (CPU), which executes various routines and processing functions of the system 10. For example, the microprocessor 12 may execute various operating system instructions as well as software routines stored in or provided by a memory 14 (such as the random access memory (RAM) of a personal computer) or one or more mass storage devices 16 (such as an internal or external hard drive, CD-ROM, DVD, or other magnetic or optical storage device). In addition, the microprocessor 12 processes data provided as inputs for various routines or software programs, such as data provided as part of the present technique in computer-based implementations.

Such data may be stored or provided by the memory 14 or mass storage device 16. Alternatively, such data may be provided to the microprocessor 12 via one or more input devices 18. As will be appreciated by those of ordinary skill in the art, the input devices 18 may include manual input devices, such as a keyboard, mouse, touchpad, and so forth. In addition the input device 18 may include a device such as a network or other electronic communication interface that provides data to the microprocessor 12 from a remote processor-based system or from another electronic device.

Results generated by the microprocessor 12, such as the results obtained by processing data in accordance with one or more stored routines, are provided to an operator via one or more output devices, such as a display 20 or printer 22. Based on the displayed or printed output, an operator may request additional or alternative processing or provide additional or alternative data, such as via the input device 18. As will be appreciated by those of ordinary skill in the art, communication between the various components of the processor-based system 10 typically is accomplished via a chipset and one or more buses or interconnects which electrically connect the components of the system 10.

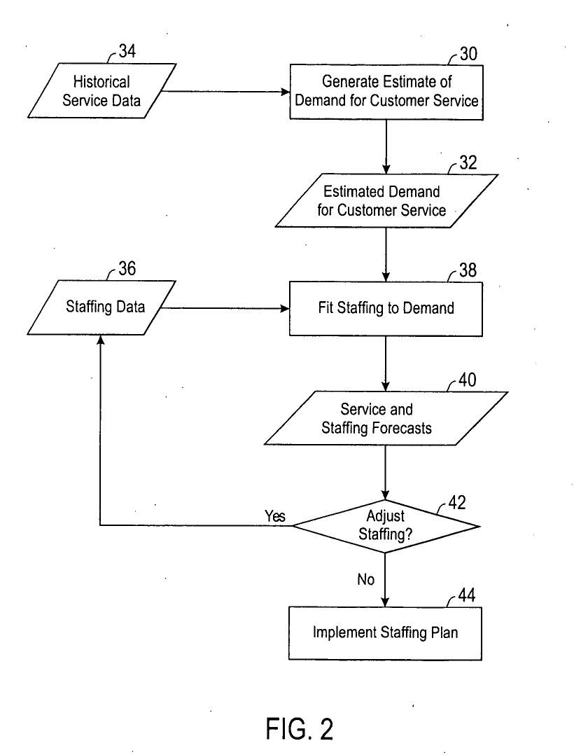

In one embodiment of the present technique, the exemplary processor-based system 10 is configured to process service and staffing data to generate summaries and/or forecasts based on the service and staffing data. Referring now to FIG. 2, exemplary steps (some or all of which may be executed by the exemplary processor-based system 10) for generating service and staffing forecasts are provided. Some or all of the steps may be performed as part of a software or spreadsheet based application. Alternatively, application specific hardware or circuitry configured to perform some or all of the steps may be utilized.

For example, at step 30 an estimate 32 of the demand for customer service over a time interval, such as over a day, week, or month, is generated. In the depicted embodiment, the demand estimate 32 is generated based upon historical service data 34. The historical data 34 may include a variety of different types of data from which service demand may be projected or forecast as well as a variety of different variables by which the estimated demand 32 may be described, parsed, or characterized. In one embodiment the demand estimate 32 relates to the demand for remote service support while in other embodiments the demand estimate relates to the demand for field service support or for both remote and field service support.

In an exemplary embodiment, the historical service data 34 may include service records pertaining to one or more customers or other service call sources, one or more geographic regions, field service calls made and their duration, remote service operations performed and their duration, and information related to the time (hour, day, week, and/or month) of previous service requests. In some embodiments, field engineers themselves may be a source of service calls tracked in the historical service data 34 if the field engineers call for remote assistance in diagnosing or addressing a service problem in the field.

Examples of some information that may be included in the historical service data 34 are the average number of customer service calls a field engineer completes per day, the number of events fixed per the total number of events for a given modality or equipment type, and the number of hours regularly scheduled for a field and/or remote shift. Other information than may be included in the historical service data 34 includes the equivalent value of remote service event assistance (such as remote diagnosis without resolution), expressed as a number of hours of a field engineer's time, and the historic remote service event assistance rate, expressed as the number of events assisted per total events for a modality or equipment type. Similarly, information such as the remote mean support service rates for both customers and field engineers may be among the information included in the historical service data 34. As will be appreciated by those of ordinary skill in the art, a variety of different variables or different types of historical service data 34 may be employed, depending on the factors to be reflected in the demand estimate 32.

For example, in an embodiment related to estimating the demand for servicing of medical equipment, such as different types of imaging devices, a variety of service call information, including information such as that described above, may be included in the historical service data 34. An example of such service call information includes the average number of remote and/or field service requests per week (or other time period) broken down by imaging modality (such as X-ray, computed tomography (CT), magnetic resonance imaging (MRI) positron emission tomography (PET), and so forth). Other examples of service call information in this context include the mean service rate for remote and/or field service requests and the percent applied time for service personnel operating in remote and/or field support capacity. In this example, historical service data 34 is provided that allows a demand estimate 32 to be generated which can be broken down or analyzed based on time (hour, day, week, and/or month), geographic region, imaging modality (or other equipment specific factors), service call type (remote and/or field) or other service related factors.

The estimated demand 32 generated from the historical service data 34 may be generated by a variety of techniques. For example, in one embodiment, estimated demand 32 may be parsed out by source (field or remote), by customer or client, by modality or equipment type, by week, day of the week, hour of the day, and so forth, or by any combination of these or other available factors. The estimated demand may represent averages for the factors of interest, such as average weekday demand by hour of the day for a modality or equipment type. Alternatively, other statistical measures, such as medians or modes may be employed. Likewise, the estimated demand 32 may be represented in terms of confidence levels or probability or by other techniques that incorporate or account for variability within the underlying data.

The estimated demand 32 generated in this manner may be visually displayed or printed for an operator to review, such as in a tabular or graphical format, or may be simply passed to subsequent processing steps without being displayed to the operator. For example, the estimated demand 32 may be provided as a table containing numeric or alpha-numeric values or as a visually-coded map, calendar, or other graphic representation. Where visual-coding is employed it may include color, gray-scale renditions, characters, symbols, or other visual indications which may be used to indicated different levels of demand.

Staffing data 36 may be fit to the estimated demand 32 at step 38 to generate a variety of service and staffing summaries and/or forecasts 40. For example, in one embodiment, the staffing data 36 includes information broken down by employee, such as days of the week and/or hours of the days the employee is on duty, geographic regions serviced by the employee, equipment (such as imaging modalities) the employee is qualified to service, clients or customers the employee is assigned to service, and whether the employee is assigned to field or remote support at the different times the employee is on duty.

Based on the staffing data 36 and the demand estimate 32, the fitting step 38 generates forecasts 40 which allow an operator to evaluate projected staffing sufficiency for remote and/or field services. In one embodiment, the forecasts 40 includes a forecast of service capacity, measured as the (number of service providers*the service rate)−(demand for service). The forecasts 40 can also include a forecast of live call answer rate, which may be broken down by source (customer or field engineer) and/or by time (hour, day, and so forth). Such a live call answer rate forecast may be provides as the projected percentage of calls answered by a remote service provider in less than a threshold time, such as three minutes from the call initiation. In such an embodiment, the probability, P₀, that a customer must wait for service may be estimated by the following equation:

$${P}_{0} = \frac{1}{[ {\sum }_{n = 0}^{n = s - 1} \frac{1}{n !} {( \frac{λ}{μ} )}^{n} ] + \frac{1}{s !} {( \frac{λ}{μ} )}^{s} ( \frac{s μ}{s μ - λ} )} \qquad ( 1 )$$

in which n is the number of customers in the system, s is the number of servers, λ is customer demand for service per hour, and μ is field engineer service rate per hour. As one of ordinary skill will appreciate, other techniques or equations may also be used to estimate customer wait times or other service related factors which may be represented probabilistically.

In a variety of embodiments the forecasts 40 are provided as run charts which include corresponding numerical tables that summarize staffing, forecasted demand for service, forecasted service capacity, and/or forecasted live call answer rate. Such charts and tables may be broken down by call source (customer or field engineer), by geographic region, by hour, by day, by equipment type or modality, and so forth.

The forecasts 40 may be visually displayed or printed for an operator to review. For example, the forecasts 40 may be provided in a tabular or graphical format. For instance, the forecasts 40 may be provided as a table containing numeric or alpha-numeric values or as a visually-coded map, calendar, or other graphic representation. Where visual-coding is employed it may include color, gray-scale renditions, characters, symbols, or other visual indications which may be used to indicated different levels of staffing sufficiency or deficiency.

In this manner, the forecasts 40 quantify or graphically represent the service capacity provided by the staffing data 36 in relation to the estimated demand 32. For example, in one embodiment a quantitative or graphical presentation of service capacity, measured as (the number of service personnel*the service rate)−(customer demand for service), may be provided for different geographic regions, for days of the week, for times of the day, or for different equipment or modality types. Similarly, a forecast 40 may quantify or graphically represent the forecasted live-call answer rate for different geographic regions, for days of the week, for times of the day, or for different equipment or modality types.

The forecasts 40 produced in this manner may be reviewed by an operator to assess whether the proposed staffing plan, represented in the staffing data 36, is sufficient to meet the estimated demand 32. In particular, the reviewer may assess the sufficiency of remote and field support levels and the tradeoff between assigning an engineer to remote support instead of the field or vice versa. As depicted at decision block 42, the reviewer may adjust the proposed staffing plan, i.e., the staffing data 36, or implement the staffing plan (step 44) based on his assessment of the forecasts 40, such as based whether a target live call answer rate is projected to be met. As one of ordinary skill in the art will appreciate, adjustments to the staffing data 36 may be iteratively made until a forecast 40 is generated that provides acceptable field and remote service coverage.

As will be appreciated by those of ordinary skill in the art, in situations where service personnel may be assigned to either the field or to a remote support site, there are tradeoffs to be considered between field and remote call center productivity and efficiency. In particular, augmenting remote service staff comes at the expense of field productivity and vice versa. The techniques described herein may be used to assess these tradeoffs, to explore alternative remote and field service assignments, and to implement staff assignments which deal with the projected field and remote service needs of a client base in an efficient or optimal manner.

For example, the techniques described herein may be used to quantify a net return on investment of adding remote service personnel to the existing remote service staff, particularly at the expense of personnel assigned to the field. For instance, the historical service data 34 may incorporate information regarding customer behavior where customers remove themselves from the queue for remote assistance due to wait times and instead page a field engineer. Such behavior is one component of any tradeoff to be explored when assigning field personnel to remote support, i.e., the decrease in remote support wait times which may result in fewer calls being redirected or “leaked” to the field.

Similarly, by incorporating remote fix and assist rates as well as multipliers representing the value of remote assistance provided to a field engineer, call and time savings may be transformed into an equivalent number of additional calls fixed by remote service personnel, such as for a geographic region, time of day, day of the week, or equipment type or modality. Net productivity of individual remote service personnel may then be calculated for any or all of these factors in order to assess the viability or value of a particular staffing plan. In this manner, the above techniques may be used to net return on investment (expressed in terms of field engineer productivity by region, time, modality, etc) and for a remote service operation in the aggregate. For example, in one embodiment the forecasts 40 may include a display or printout of the estimated number of service requests will be resolved remotely for a shift or other time period. In addition, the forecasts 40 may include the net remote service personnel productivity, measured as the estimated number of service events a remote service engineer will fix during a shift versus the equivalent time spent as a field engineer servicing requests in the field). Similarly, the forecasts 40 may include the net impact to the field capacity for a region, measured as the net remote service engineer productivity translated into a +/−field engineer headcount. Any or all of these exemplary factors, or other factors calculable by the above techniques, may be used to evaluate whether a given staffing plan, as represented in staffing data 36, is costly or beneficial to a combined remote and field service operation. In this manner, a reviewer may adjust remote or field staff levels and schedules to achieve a staffing plan which is optimized, or at least sufficient, in terms of force productivity.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method, comprising:
automatically calculating an estimate of demand for field and for remote customer service; and
automatically calculating a forecast based upon the estimate of demand and on a staffing plan allocating service personnel between field and remote assignments.

2. The method of claim 1, comprising:
adjusting the staffing plan based upon the forecast.

3. The method of claim 1, comprising:
implementing the staffing plan.

4. The method of claim 1, wherein automatically calculating the estimate of demand comprises automatically calculating the estimate of demand for field and for remote customer service based on historical service data.

5. The method of claim 4, wherein the historical service data comprises at least one of service records for one or more customers, for one or more geographic regions, for one or more equipment types, or for one or more time periods.

6. The method of claim 1, wherein automatically calculating the estimate of demand comprises parsing demand by one or more service variables.

7. The method of claim 6, wherein the one or more service variables comprise at least one of a service call source variable, a customer variable, a equipment type variable, or a time frame variable.

8. The method of claim 1, wherein the estimate of demand comprises at least one of an average, a median, a mode, a confidence level, or a probabilistic measure.

9. The method of claim 1, comprising displaying or printing at least one of the estimate of demand or the forecast.

10. The method of claim 1, wherein the staffing plan comprises employee information related to at least one of a schedule, a geographic assignment, a list of equipment each employee is qualified to service, or a list of customers each employee is qualified to service.

11. The method of claim 1, comprising quantifying at least one of a remote or a field productivity associated with the staffing plan.

12. A processor-based system, comprising:
a microprocessor configured to calculate an estimate of demand for field and for remote customer service based on historical service data and to calculate a forecast based upon the estimate of demand and on a staffing plan allocating service personnel between field and remote assignments.

13. The processor-based system of claim 12, wherein the historical service data is acquired from at least one of an input device, a memory, or a mass storage device.

14. The processor-based system of claim 12, wherein the microprocessor calculates the estimate of demand by parsing demand based on one or more service variables.

15. The processor-based system of claim 12, wherein the microprocessor is further configured to display at least one of the estimate of demand or the forecast on a display or to print at least one of the estimate of demand or the forecast on a printer.

16. The processor-based system of claim 12, wherein the staffing plan is acquired from at least one of an input device, a memory, or a mass storage device.

17. The processor-based system of claim 12, wherein the microprocessor is further configured to quantify at least one of a remote or a field productivity associated with the staffing plan.

18. A computer-readable medium, comprising:
a routine for calculating an estimate of demand for field and for remote customer service; and
a routine for calculating a forecast based upon the estimate of demand and on a staffing plan allocating service personnel between field and remote assignments.

19. The computer-readable medium of claim 18, wherein the routine for calculating the estimate of demand calculates the estimate of demand for field and for remote customer service based on historical service data.

20. The computer-readable medium of claim 18 comprises a routine for displaying or a routine for printing at least one of the estimate of demand or the forecast.

21. The computer-readable medium of claim 18 comprises a routine for quantifying at least one of a remote or a field productivity associated with the staffing plan.
